(19) United States
(12) Patent Application Publication
(10) Pub. No.: US 2018/0063007 A1
(43) Pub. Date: Mar. 1, 2018

(54) MICROBURST BUFFERING CIRCUIT

(71) Applicant: Viavi Solutions Inc., Milpitas, CA (US)

(72) Inventor: Sherwood JOHNSON, Shakopee, MN (US)

(73) Assignee: Viavi Solutions Inc., Milpitas, CA (US)

(21) Appl. No.: 15/252,988

(22) Filed: Aug. 31, 2016

(51) Int. Cl. H04L 12/835; H04L 12/935; H04L 12/801

(52) U.S. Cl. CPC H04L 47/30; H04L 47/29; H04L 49/3027; H04L 49/3018

(57) ABSTRACT

A microburst buffering circuit can buffer packets received on an ingress port based in a capacity of a destination buffer of an egress port. A controller may toggle between bypassing a microburst packet buffer and temporarily storing packets in the microburst packet buffer based on the available capacity of the destination buffer.

### BACKGROUND

A microburst is a condition in a data communication network where an unusually large amount of data is received by the network at the same place in a very short time frame. Typical microbursts last usually less that one millisecond, and they typically occur during high communication traffic volume. The microburst is a problem in a communication network because it saturates the network and adds to latency in data transmission. Data packets may be dropped because of a microburst in a system that is not designed to accept the sudden influx of data. Also, the dropped packets may be retransmitted at the cost of several milliseconds, which can nearly double the time for transmission, disrupt packet transmission flow, and wastes bandwidth. Microbursts are common in data transmission networks, but can be so brief that for certain applications they do not cause a problem. However, other applications are more sensitive to microburst disturbance, such as audio, video, or multicast applications where the order of data packet receipt and minimal latency are important.

### BRIEF DESCRIPTION OF DRAWINGS

Features of the present disclosure are illustrated by way of examples shown in the following figures. In the following figures, like numerals indicate like elements, in which:

FIG. 1 shows a block diagram of a system including a microburst buffering circuit, according to an example of the present disclosure;

FIG. 2 shows a controller, according to an example of the present disclosure; and

FIG. 3 shows a method, according to an example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

According to an example of the present disclosure, a microburst buffering circuit includes a microburst packet buffer connected to destination buffers. The microburst packet buffer may be an intermediate buffer between ingress ports of a receiver receiving packets and egress ports transmitting the packets toward their destinations. The egress ports include destination buffers to store packets waiting to be transmitted from the egress ports. A controller determines whether a destination buffer is almost full, such as whether the buffer is filled to a predetermined percentage of its full capacity. Almost full may also include when available capacity of the destination buffer falls below a predetermined threshold. Available capacity is the amount of storage capacity that is currently available to store data. In an example, the predetermined threshold may be 10% of total capacity of the destination buffer. In this example, if the available capacity is less than 10% (e.g., the destination buffer is over 90% full), then the destination buffer is considered almost full. Other thresholds may be used for the predetermined threshold. If the destination buffer is almost full, the microburst packet buffer is enabled to store packets to be transmitted from the egress port having the destination buffer that is almost full received packets; otherwise the microburst packet buffer is bypassed and the packets are transmitted to the egress port without being stored in the microburst packet buffer. Accordingly, if a microburst occurs, causing destination packet buffers of egress ports to become almost full, the microburst packet buffer can store the packets instead of the packets being dropped. The microburst buffering circuit may be used to process microbursts of data in a data communication system to reduce or avoid delay (latency), lost data, flicker, or other problems associated with a system receiving a microburst of data.

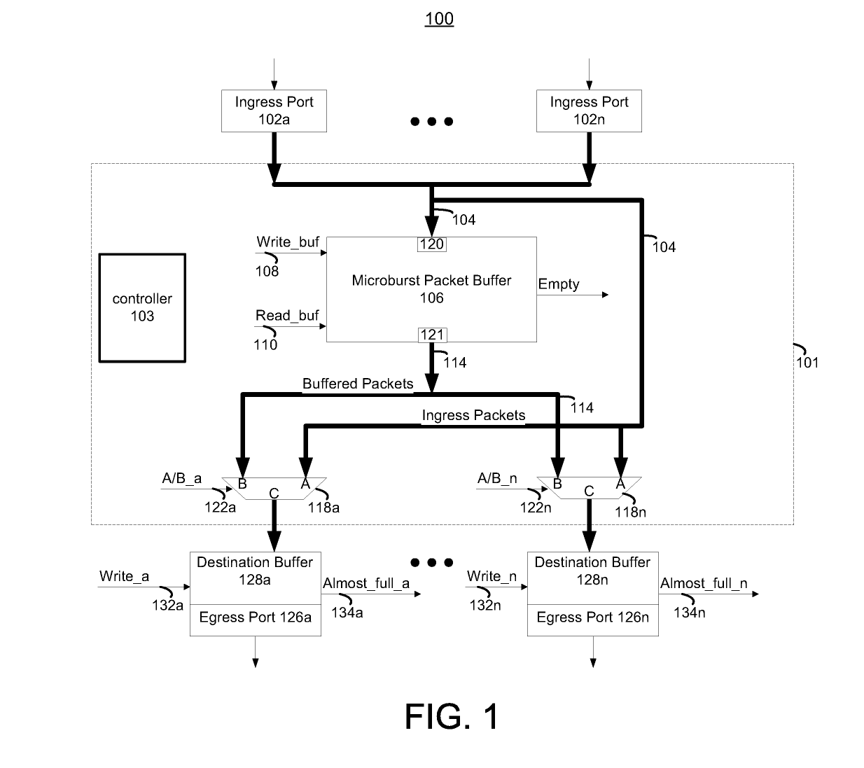

FIG. 1 shows a block diagram of a system 100 including a microburst buffering circuit 101, according to one example of the present disclosure. The system 100 may include a receiver or a transceiver connected to a data communication network to receive network traffic, e.g., packets, therefrom or to send and receive network traffic. The system 100 may be designed to receive high speed network traffic, such as 1/10/40/100 Gigabits per second (Gbps) or greater, and transmit the network traffic to its destination. The system 100 may transmit the network traffic to its destination at line rates via egress ports 126. In an example, the system 100 is a subcomponent of a capture card that is connected to a data communication network to receive network traffic and send the network traffic to one or more other devices, which may be servers, data storage systems, etc. The capture card may be included in a network appliance for capturing, storing, and analyzing network traffic over a period of time. In an example, the network appliance comprises the capture card connected to a data storage device, such as a Redundant Array of Independent Disks (RAID), to capture the network traffic and store the network traffic in the data storage device. The network appliance may be part of a network management system for monitoring and managing network traffic. The network appliance may be a rack-mounted appliance and may be used to capture network traffic between servers. In another example, the system 100 is a subcomponent of a router that routes packets to their destinations via a network.

The system 100 may include ingress ports 102, which may be a plurality of ingress ports a through n (where a is equal to 1 and n is an integer greater than 1). The ingress ports 102 are network ports that accept network traffic including data packets. In an example, the data packets may include Internet Protocol version 4 (IPv4) or Internet Protocol version 6 (IPv6) packets but data transmitted to according to any network protocol may be received via where data packets are received and captured. The data packets may be part of a packet stream that is being transmitted to a destination. The packets may be captured at the ingress ports 102, and then aggregated to common higher bandwidth stream.

The received data packets may be transmitted from the ingress ports 102 to the microburst buffering circuit 101 and egress ports 126 via data transmission line 114. The microburst buffering circuit 101 may include controller 103, microburst packet buffer 106, and switches 118. The microburst buffering circuit 101 may be embodied in an integrated circuit or as discrete components on a circuit board. As is further discussed below, packets received via the ingress ports 102 are either written to the microburst packet buffer 106, or the packets bypass the microburst packet buffer 106 and are transmitted directly to the egress ports 126 via data transmission line 104 depending on whether destination buffers 128 of the egress ports 126 are almost full. For example, the egress ports 126 receive the packets directly from the ingress ports 102 until the destination buffers 128 become almost full. At that point, any packets destined for the egress ports 126 are diverted to the microburst packet buffer 106. When the destination buffers 128 become not almost full, e.g., the available capacity of the destination buffers 128 is greater than a predetermined threshold, the egress ports 126 may continue to accept packets from the microburst packet buffer 106 until it is drained for the particular destination egress port and then switch to receiving the packets directly from the ingress ports 102 via line 104.

The microburst packet buffer 106 may include data input 120, data output 121, control inputs including write control input 108 and read control input 110, and a control output including empty control output 112. The microburst packet buffer 106 may receive data packets via data transmission line 104 on data input 120. Controller 103 may include a hardware circuit to perform the operations described herein. For example, the controller 103 may include a field Programmable Gate Arrays (FPGA), Application Specific Integrated Circuit (ASIC), and/or a microcontroller. The controller 103 may determine whether the destination buffers 128 are almost full. If any of the destination buffers 128 are almost full, the controller 103 generates a write enable signal on the write control input 108 to store packets received via the ingress ports 102 on the data input 120 that are destined for the almost full destination buffer. Receiving the read enable signal enables the microburst packet buffer 106 to send stored packets from a data output 121 via data transmission line 114 to the egress port. Empty control output 112 indicates whether packets for a particular destination buffer are currently stored in the microburst packet buffer 106. Empty control output 112 may be used by the controller 103 to determine whether all the packets for a particular egress port that are currently stored in the microburst packet buffer 106 have been drained from the microburst packet buffer 106 before switching to sending packets via line 104 to the egress port as is further discussed below.

Received packets transmitted either directly from the ingress ports via data transmission line 104 to the egress ports 126 or transmitted from the microburst packet buffer 106 via data transmission line 114 to the egress ports 126 go through switches 118. There may be a plurality of the switches 118 (e.g., a through n) as shown in FIG. 1, and each switch may operate similarly. The switches 118 may each have two inputs, shown as A and B, and one output C. One of inputs is passed through the output C. For example, the switches 118 are multiplexors. Selection input 122 is connected to a selection line to receive a A/B signal from the controller 103 to enable input A or B. Whichever input is enabled is passed through to the connected egress port. For example, if switch 118a has input A enabled, then the data packets from line 104 are transmitted directly to the egress port 126a and destination buffer 128a. If switch 118a has input B enabled, then the data packets are transmitted from the microburst packet buffer 106 to egress port 126a and destination buffer 128a via data transmission line 114.

Each of the egress ports 126 may include a destination buffer, shown as destination buffers 128. The destination buffers 128 temporarily hold the data packets before transmitting the data packets to their destination out the egress ports 126. The destination buffers 128 may have control line inputs 132 to enable writing to the destination buffer and may status outputs 134 to indicate whether the destination buffer is almost full.

The destination buffers 128 may include status signal circuits that determine the current capacity of the destination buffers 128, such as whether they are almost full, by any suitable method, which may include tracking packet length from information in the data packet header, reading the end of packet (EOP) at the trailer of the packet, tracking bits processed in packets with standard length, or another suitable technique to determine the contents of the destination buffer. The current capacity of the destination buffer may be determined by an application appropriate status designation such as empty, almost empty, almost full, or full, as may be practiced without limitations in these disclosures and without departing from a scope of the microburst buffering circuit 100.

The current capacity of the destination buffer, which may be output from status output 134, may be read by controller 103 in order for the controller 103 to determine whether to generate a write enable at 108 and a read enable at 110, and to determine whether to enable input A or B of the switch 119. When the destination buffer is at an almost full status, write is enabled at 108 and read is enabled at 110, and switch input B is enabled. When the destination buffer is not at an almost full status, write is disabled at 108 and read may be disabled at 110 (such as after packets destined for the destination buffer that are stored in the microburst packet buffer 106 are transmitted to the destination buffer), and switch input A is enabled.

In an example of a data packet diverted to microburst packet buffer 106, the rest of the packets associated with the first packet are also diverted to go through microburst packet buffer 106. For example, a packet flow of associated data packets following from the first data packet are also diverted through microburst packet buffer 106 in order to ensure that the packet flow arrives sequentially ordered to the destination buffer 128. Further, in order to ensure sequentially ordered packet flow, while switch 118 has input B enabled, all packets destined for the connected destination buffer go through the microburst packet buffer 106 even if the status signal circuit indicates that the destination buffer is not almost full. For example, after all data packets destined for the destination buffer 128 have been drained from microburst packet buffer 106, then the controller may enable input A on switch 118 to permit data packets to be transmitted directly from the ingress ports 102 to the destination buffer.

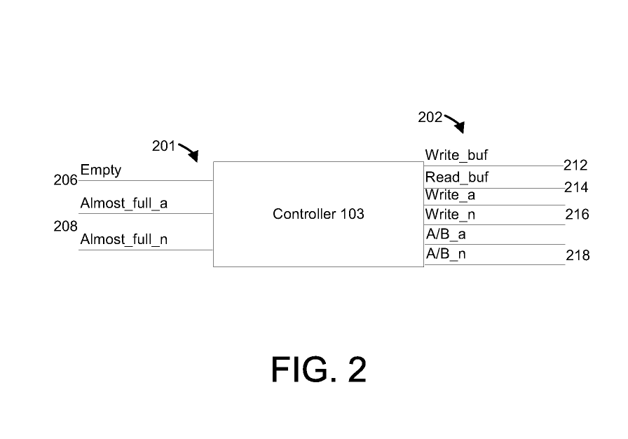

FIG. 2 shows an example of control inputs 201 and control outputs 202 of the controller 103. The control inputs 201 may include empty 206 and Almost_full_a-n 208. Empty 206 is provided from the microburst packet buffer 106 and indicates whether the microburst packet buffer 106 is empty and has been drained of temporarily stored packets. Almost_full_a-n 208 are provided from the destination buffers 128 and indicate whether the destination buffers 128 are almost full or not. As indicated above, a threshold may be set for available space of each destination buffer. In an example, if the amount of available of space in a destination buffer is less than or equal to the threshold, then the destination buffer may enable its Almost_full_n signal which indicates to the controller 103 that the destination buffer is almost full (or full). Otherwise, the Almost_full_n signal is disabled to indicate to the controller 103 that the destination buffer is not almost full.

The control outputs 202 of the controller 103 may include Write_buf 212 and Read_buf 214, Write_a-n 216 and A/B_a-n 218. Write_buf 212 and Read_buf 214 enable the reading and writing to the microburst packet buffer 106. Write_a-n 216 enable writing to each of the destination buffers 128. A/B_a-n 218 are the selection signals that enable either input A or B for each of the switches 118.

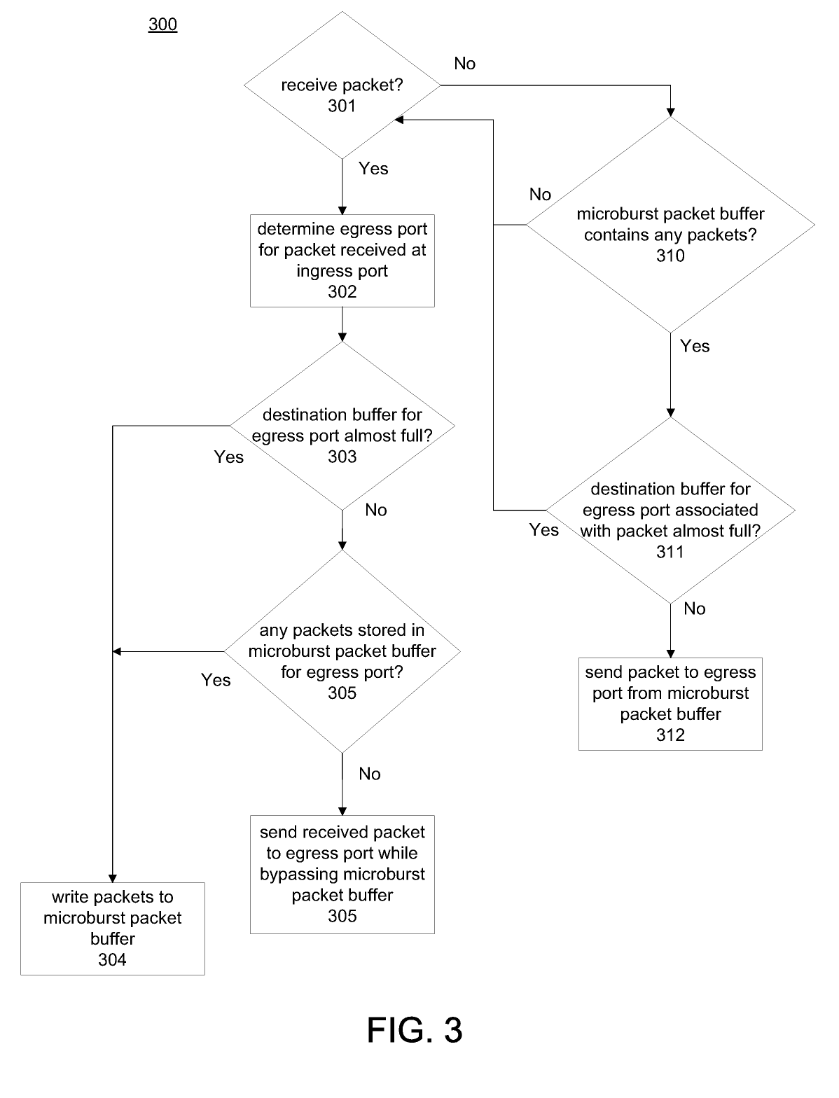

FIG. 3 illustrates a method 300, according to an example of the present disclosure. One or more steps of the method 300 may be performed by the microburst buffering circuit 101. At 301, a determination is made to as to whether a packet is received on any of the ingress ports 102. For example, the ingress ports 102 are connected to a network, and the system 100 receives data packets transmitted via the network at the ingress ports 102.

If a packet is received, at 302, an egress port of the egress ports 126 is determined for transmitting the received data packet from the system 100 toward its destination. The controller 103 may determine the egress port for the newly received packet. In an example, each of the egress ports 126 may be associated with source or destination addresses of the packet, and the packet is transmitted to the egress port associated with the packet's source or destination. In this example, a routing table may be maintained that identifies the egress port based on a source or destination address in the received packet, and the packet is internally forwarded to that egress port for transmission toward its destination via a network. In another example, the egress ports 126 may be connected to a data storage system or device that is for capturing network traffic for further analysis. The controller 103 may select an egress port for forwarding each packet to the data storage system or device for storage. The egress port may be selected based on a round-robin technique or another load balancing technique so as not to overload the egress ports 126.

At 303, a determination is made as to whether the destination buffer of the egress port determined at 302 is at an almost full status. For example, the almost full status is achieved when the available capacity of the destination buffer is less than a predetermined threshold. The controller 103 may make the determination based on the almost full signal 134 that indicates the status of the destination buffer. The destination buffer of the egress port is the destination buffer storing packets waiting to be transmitted from the egress port. For example, assume the egress port 126a is determined at 302 for the received packet. The destination buffer 128a is the destination buffer for the egress port 126a as shown in FIG. 1.

If the destination buffer of the egress port is determined to be at the almost full status, at 304, the received data packet is written to the microburst packet buffer 106.

If the destination buffer is determined not to be at the almost full status (e.g., available capacity of the destination buffer is greater than the predetermined threshold or greater than or equal to the predetermined threshold), at 305, a determination is made as to whether any data packets are stored in the microburst packet buffer 106 that need to be sent from the microburst packet buffer 106 to the egress port. For example, the controller 103 may maintain a table that indicates packets currently stored in the microburst packet buffer 106 and the egress port for each packet, and the controller 103 may determine whether the microburst packet buffer 106 is storing packets that need to be sent from the microburst packet buffer 106 to the egress port 126a.

If any packets are currently stored in the microburst packet buffer 106 that need to be sent to the egress port (e.g., egress port 126a identified at 302), at 304, the packet determined to be received at 301 is stored in the microburst packet buffer 106. Also, the controller 103 selects input B or maintains a selection of input B (e.g., input B is enabled) for switch 118a shown in FIG. 1, so the packets for egress port 126a stored in the microburst packet buffer 106 continue to be moved to the egress port 126a until the microburst packet buffer 106 does not have any more packets for the egress port 126a. This facilitates maintaining the order of transmission packets. For example, the microburst packet buffer 106 operates as a first-in-first-out (FIFO) buffer for each egress port to maintain the order of the packets. Assume the microburst packet buffer 106 currently stores packets A, B and C received in that order that are to be transmitted form egress port 126a. The controller 103 empties microburst packet buffer 106 of packets A, B, C in that order so the packets are transmitted from egress port 126a in that order without allowing any newly received packets to be provided to the egress port 126a directly from the ingress ports 102 until the packets A-C are sent to the egress port 126a.

If no packets are currently stored in the microburst packet buffer 106 that need to be sent to the egress port 126a, at 306, the received packet is sent to the egress port 126a while bypassing the microburst packet buffer 106. For example, referring to FIG. 1, the controller 103 enables input A on the switch 118a, and the received packet is sent directly to the egress port 126a via line 104 while bypassing the microburst packet buffer 106. The packet is written to the destination buffer 128a for transmission from the egress port 126a.

If a determination is made at 301 that no packet is received on the ingress ports 102, at 310, a determination is made, e.g., by the controller 103, as to whether any packets are stored in the microburst packet buffer 106. Assuming packets are removed from the microburst packet buffer 106 when they are transmitted from the microburst packet buffer 106 to the egress ports 126, then any packets stored in the microburst packet buffer 106 need to be transmitted to an egress port associated with the packet. If a determination is made at 310 that the microburst packet buffer 106 is empty, then the system 100 waits for the next packet to be received at 301. If a determination is made at 310 that the microburst packet buffer 106 contains a packet, at 311, a determination is made as to whether the destination buffer for the egress port associated with the packet is at an almost full status. As indicated above, the almost full status is achieved when the available capacity of the destination buffer is less than a predetermined threshold. Also, as discussed above with respect to step 302, the controller 103 may identify the egress port associated with each received packet, such as the egress port from which the packet is to be transmitted to its destination.

If the destination buffer is determined to be at an almost full status (e.g., the available capacity is less than a predetermined threshold), then the method returns to 301. If the destination buffer is determined not to be at the almost full status, at 311, the packet is sent from the microburst packet buffer 106 to the egress port associated with the packet.

The controller 103 can control the switches 122 individually to control the packets destined for particular egress ports independently. Accordingly, packets destined for a particular egress port (e.g., egress port 126a) may be transmitted directly to the egress port 126a if the destination buffer 128a has available capacity greater than the predetermined threshold, regardless of the available capacity of other destination buffers.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

What is claimed is:

1. A microburst buffering circuit to buffer packets received on an ingress port, the microburst buffering circuit comprising:
a controller;
a microburst packet buffer; and
a switch connected to an egress port including a destination buffer operable to temporarily store packets to be transmitted from the egress port,
wherein the controller is to:
determine whether an available capacity for storing data in the destination buffer is less than a predetermined threshold; and
if the available capacity for storing data in the destination buffer is determined to be less than the predetermined threshold, control the switch to pass the packets to the egress port via the microburst packet buffer; otherwise, control the switch to pass the packets to the egress port while bypassing the microburst packet buffer.

2. The microburst buffering circuit of claim 1, wherein subsequent to controlling the switch to pass packets to the egress port via the microburst packet buffer, the controller is to:
determine the available capacity for storing data in the destination buffer is greater than a predetermined threshold;
determine whether the microburst packet buffer is currently storing any other packets to be moved from the microburst packet buffer to the egress port; and
if the microburst packet buffer is determined to be storing a packet to be moved to the egress port, maintain the switch to pass packets from the microburst packet buffer to the egress port until the microburst packet buffer does not contain any packets to be transmitted to the egress port, and then control the switch to transmit newly received packets to the egress port while bypassing the microburst packet buffer.

3. The microburst buffering circuit of claim 2, wherein to determine whether the microburst packet buffer is currently storing any other packets to be moved from the microburst packet buffer to the egress port, the controller is to determine whether the microburst packet buffer is currently storing any other packets for the same packet flow.

4. The microburst buffering circuit of claim 1, wherein if the available capacity for storing data in the destination buffer is determined to be less than a predetermined threshold, the controller is to:
enable the microburst packet buffer to store the packets to be transmitted to the egress port; and
enable the microburst packet buffer to transmit the packets from the microburst packet buffer to the egress port.

5. The microburst buffering circuit of claim 4, wherein the microburst packet buffer is to temporarily store the packets to be transmitted to the egress port, and the packets are removed from the microburst packet buffer when transmitted from the microburst packet buffer to the egress port.

6. The microburst buffering circuit of claim 1, wherein the switch comprises a multiplexor including a first input connected to a first data transmission line connected to the ingress port and a second input connected to a second data transmission line connected to a data output of the microburst packet buffer,
wherein the controller is to select either the first input or the second input based on the available capacity of the destination buffer.

7. The microburst buffering circuit of claim 1, wherein the controller is to enable or disable writing to the destination buffer based on whether packets are to be transmitted from the microburst packet buffer to the egress port.

8. The microburst buffering circuit of claim 1, comprising:
a plurality of ingress ports to receive packets; and
a plurality of egress ports, each having a destination buffer operable to temporarily store packets to be transmitted from the egress port,
wherein the controller is to determine an egress port for sending a packet received on one of the ingress ports, and if the destination buffer for the determined egress port has an available capacity greater than the predetermined threshold, the packet is transmitted from the one of the ingress ports to the determined egress port while bypassing the microburst packet buffer even if another one of the destination buffers has an available capacity less than the predetermined threshold.

9. An apparatus comprising:
ingress ports to receive packets from a data communication network;
egress ports to transmit the packets to at least one destination; and
a microburst buffering circuit comprising:
a controller; and
a microburst packet buffer connected between the ingress ports and the egress ports and operable to temporarily store packets to be transmitted from the ingress ports to the egress ports,
wherein the controller is to:
enable the received packets to be transmitted to an egress port of the egress ports to be stored in the microburst packet buffer if a destination buffer of the egress port has an available capacity less than a predetermined threshold; and
enable the received packets to be transmitted to the egress port while bypassing the microburst packet buffer if the available capacity of the destination buffer is greater than or equal to the predetermined threshold.

10. The apparatus of claim 9, wherein the microburst buffering circuit comprises:
a switch including a first input connected to a first data transmission line connected to the ingress ports and a second input connected to a second data transmission line connected to a data output of the microburst packet buffer,
wherein the controller is to select either the first input or the second input based on the available capacity of the destination buffer.

11. The apparatus of claim 10, wherein the controller is to:
select the first input if the available capacity of the destination buffer of the egress port is greater than or equal to the predetermined threshold; and
select the second input if the available capacity of the destination buffer of the egress port is less than the predetermined threshold.

12. The apparatus of claim 9, wherein if the available capacity of the destination buffer of the egress port is less than the predetermined threshold, the controller is to enable the received packets stored in the microburst packet buffer to be transmitted from the microburst packet buffer to the egress port.

13. The apparatus of claim 12, wherein subsequent to enabling the received packets stored in the microburst packet buffer to be transmitted from the microburst packet buffer to the egress port, the controller is to:
determine the available capacity of the destination buffer of the egress port is greater than or equal to the predetermined threshold;
determine whether the microburst packet buffer is currently storing any packets to be moved from the microburst packet buffer to the egress port; and
if the microburst packet buffer is determined to be storing any packets to be moved to the egress port, maintain the enabling of transmitting packets from the microburst packet buffer to the egress port until the microburst packet buffer does not contain any packets to be transmitted to the egress port, and then enable newly received packets to be transmitted to the egress port while bypassing the microburst packet buffer.

14. The apparatus of claim 13, wherein to determine whether the microburst packet buffer is currently storing any other packets to be moved from the microburst packet buffer to the egress port, the controller is to determine whether the microburst packet buffer is currently storing any packets for the same packet flow.

15. The apparatus of claim 9, wherein the microburst packet buffer is to temporarily store the packets to be transmitted to the egress port, and the packets are removed from the microburst packet buffer when transmitted from the microburst packet buffer to the egress port.

16. The apparatus of claim 9, wherein the controller is to enable or disable writing to the destination buffer based on whether packets are to be transmitted from the microburst packet buffer to the egress port.

17. The apparatus of claim 9, wherein the controller is to determine an egress port for sending a packet received on one of the ingress ports, and if the destination buffer for the determined egress port has an available capacity greater than the predetermined threshold, the packet is transmitted from the one of the ingress ports to the determined egress port while bypassing the microburst packet buffer even if another one of the destination buffers has an available capacity less than the predetermined threshold.

18. A method comprising:
receiving packets from a data communication network at ingress ports of an apparatus,
wherein the ingress ports are connected to egress ports of the apparatus via a first data transmission line that bypasses a microburst packet buffer connected between the ingress ports and the egress ports, and the ingress ports are connected to the egress ports via a second data transmission line that includes the microburst packet buffer;
if an available capacity for storing data in a destination buffer of an egress port of the egress ports is less than a predetermined threshold,
enabling the microburst packet buffer to store the packets, and enabling the received packets to be transmitted to the egress port from the microburst packet buffer via the second data transmission line; and
if the available capacity of the destination buffer of the egress port is greater than or equal to the predetermined threshold, enabling the received packets to be transmitted to the egress port while bypassing the microburst packet buffer via the first data transmission line.

19. The method of claim 18, comprising:
wherein subsequent to enabling the received packets stored in the microburst packet buffer to be transmitted from the microburst packet buffer to the egress port, determining the available capacity of the destination buffer of the egress port is greater than or equal to the predetermined threshold;
determining whether the microburst packet buffer is currently storing any packets to be moved from the microburst packet buffer to the egress port; and
if the microburst packet buffer is determined to be storing any packets to be moved to the egress port, maintain the enabling of transmitting packets from the microburst packet buffer to the egress port until the microburst packet buffer does not contain any packets to be transmitted to the egress port; and
enabling newly received packets to be transmitted to the egress port via the first data transmission line while bypassing the microburst packet buffer.

20. The method of claim 18, comprising:
toggling a switch between the first and second data transmission lines based on a capacity of the destination buffer.
